(19) United States
(12) Patent Application Publication
(10) Pub. No.: US 2026/0339458 A1
(43) Pub. Date: Oct. 29, 2026

(54) TOUCH SENSOR FIRST-TOUCH LATENCY AND IDLE POWER REDUCTION

(71) Applicant: Microchip Touch Solutions Limited, Wokingham (GB)

(72) Inventors: Richard P. Collins, Southampton (GB); Martin Kettle, Southampton (GB); Paul J. Heslop, Eastleigh (GB)

(73) Assignee: Microchip Touch Solutions Limited, Wokingham (GB)

(21) Appl. No.: 19/211,227

(22) Filed: May 18, 2025

Related U.S. Application Data
(60) Provisional application No. 63/794,140, filed on Apr. 24, 2025.

(51) Int. Cl. G06F 3/041; G06F 3/044

(52) U.S. Cl. CPC G06F 3/04166; G06F 3/0446

(57) ABSTRACT

A capacitive sensing system has transmit electrodes and receive electrodes positioned to have mutual capacitances therebetween at mutual capacitance nodes, wherein the mutual capacitance at respective ones of the mutual capacitance nodes changes when an interfering object is proximate. The capacitive sensing system may be operated in an idle mode when no change of a mutual capacitance is detected within an idle wait interval, and operated in an active mode when a change of a mutual capacitance is detected within an active wait interval, wherein the idle wait interval is longer than the active wait interval.

### PRIORITY

This application claims priority to U.S. Provisional Patent Application No. 63/794,140, filed Apr. 24, 2025, the contents of which are hereby incorporated in their entirety for all purposes.

### TECHNICAL FIELD

The present application relates to touch sensors, and more particularly to fast scanning touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch sensor controller may process the change in capacitance to determine the position of the change in capacitance on the touch screen.

There is a need for touch screen systems and methods to save power and speed up initial touch latency.

### SUMMARY

According to aspects, there is provided a method comprising: providing a capacitive sensing system comprising first and second transmit electrodes and a receive electrode positioned to have mutual capacitances between the first and second transmit electrodes and the receive electrode at mutual capacitance nodes, wherein the mutual capacitance at respective ones of the mutual capacitance nodes changes when an interfering object is proximate; operating the capacitive sensing system in an idle mode when no change of a mutual capacitance is detected within an idle wait interval; and operating the capacitive sensing system in an active mode when a change of a mutual capacitance is detected within an active wait interval, wherein the idle wait interval is longer than the active wait interval.

Aspects as in the preceding paragraph provide a method, wherein the active mode identifies whether a mutual capacitance node has a changed mutual capacitance, and wherein the idle mode identifies which mutual capacitance node has a changed mutual capacitance.

Aspects as in one of the preceding two paragraphs provide a method, wherein the idle mode comprises applying an idle drive pattern to the first and second transmit electrodes, and wherein the active mode comprises: applying an active drive pattern to the first and second transmit electrodes.

Aspects as in one of the preceding three paragraphs provide a method, wherein applying the idle drive pattern comprises applying simultaneously at least a portion of a single codeset to both the first and second transmit electrodes, and wherein applying the active drive pattern comprises applying at least portions of different codesets respectively to the first and second transmit electrodes.

Aspects as in one of the preceding four paragraphs provide a method, wherein operating the capacitive sensing system in the idle mode comprises: applying simultaneously a first drive signal comprising a codeset to the first and second transmit electrodes; receiving a receive signal via the receive electrode; and decoding the receive signal to determine whether there is a change in a mutual capacitance at a mutual capacitance node; and wherein operating the capacitive sensing system in the active mode comprises: applying a first drive signal comprising a first codeset to the first transmit electrode and a second drive signal comprising a second codeset to the second transmit electrode; receiving a receive signal via the receive electrode; and decoding the receive signal to identify which mutual capacitance node has changed mutual capacitance.

Aspects as in one of the preceding five paragraphs provide a method, further comprising: switching between operating the capacitive sensing system in the idle mode and operating the capacitive sensing system in the active mode.

Aspects as in one of the preceding six paragraphs provide a method, wherein switching is based on whether a change in a mutual capacitance is detected.

According to aspects, there is provided a system comprising: first and second transmit electrodes and a receive electrode positioned to have mutual capacitances between the first and second transmit electrodes and the receive electrode at mutual capacitance nodes, wherein the mutual capacitance at respective ones of the mutual capacitance nodes changes when an interfering object is proximate; a drive signal generator circuit to apply a drive pattern to the first and second transmit electrodes; a receive signal receiver circuit to receive a receive signal from the receive electrode; logic circuitry to: decode the receive signal to detect a change of a mutual capacitance; operate the capacitive sensing system in an idle mode when no change of a mutual capacitance is detected within an idle wait interval; and operate the capacitive sensing system in an active mode when a change of a mutual capacitance is detected within an active wait interval, wherein the idle wait interval is longer than the active wait interval.

Aspects as in the preceding paragraph provide a system, wherein the idle mode identifies whether a mutual capacitance node has a changed mutual capacitance, and wherein the active mode identifies which mutual capacitance node has a changed mutual capacitance.

Aspects as in one of the preceding two paragraph provide a system, wherein the idle drive pattern comprises a single codeset with portions of which to be simultaneously applied to both the first and second transmit electrodes, and wherein the active drive pattern comprises different codesets with portions of which to be respectively applied to the first and second transmit electrodes.

Aspects as in one of the preceding three paragraph provide a system, wherein the logic circuitry is to operate in the idle mode by: applying simultaneously a first drive signal comprising a codeset with portions being applied to the first and second transmit electrodes; receiving a receive signal via the receive electrode; and decoding the receive signal to determine whether there is a change in a mutual capacitance at a mutual capacitance node; and wherein the logic circuitry is to operate in the active mode by: applying a first drive signal comprising a first codeset with a portion being applied to the first transmit electrode and a second drive signal comprising a second codeset with a portion being applied to the second transmit electrode; receiving a receive signal via the receive electrode; and decoding the receive signal to identify which mutual capacitance node has changed mutual capacitance.

Aspects as in one of the preceding three paragraph provide a system, wherein the logic circuitry is to switch between operating the capacitive sensing system in the idle mode and operating the capacitive sensing system in the active mode.

Aspects as in one of the preceding four paragraph provide a system, wherein switching is based on whether a change in a mutual capacitance is detected.

According to aspects, there is provided a method comprising: generating an idle drive pattern; applying an idle drive signal based on the idle drive pattern to a first transmit electrode and a second transmit electrode; receiving an idle receive signal from a receive electrode, wherein a mutual capacitance at respective ones of the mutual capacitance nodes between the first and second transmit electrodes and the receive electrode changes when an interfering object is proximate; decoding the idle receive signal to determine whether a mutual capacitance has changed; generating an active drive pattern when it is determined that a mutual capacitance has changed; generating an active drive pattern; applying an active drive signal based on the active drive pattern to the first transmit electrode and the second transmit electrode; receiving an active receive signal from a receive electrode; decoding the active receive signal to determine which mutual capacitance has changed.

Aspects as in the preceding paragraph provide a method, comprising waiting an idle wait interval.

Aspects as in one of the preceding two paragraphs provide a method, comprising waiting an active wait interval, wherein the idle wait interval is longer than the active wait interval.

Aspects as in one of the preceding three paragraphs provide a method, wherein the idle drive pattern comprises an idle codeset, wherein the active drive pattern comprises an active codeset, and wherein the idle codeset is applied to more transmit electrodes than the active codeset.

Aspects as in one of the preceding four paragraphs provide a method, wherein respective codebits of the idle codeset are orthogonal to other respective codebits in the idle codeset to allow for simultaneous driving of multiple transmit electrode, and wherein respective codebits of the active codeset are orthogonal to other respective codebits in the active codeset to allow for simultaneous driving of multiple transmit electrodes.

Aspects as in one of the preceding five paragraphs provide a method, wherein the idle drive pattern comprises an idle wait interval, wherein the active drive pattern comprises an active wait interval, and wherein the idle wait interval is longer than the active wait interval.

Aspects as in one of the preceding six paragraphs provide a method, wherein decoding the idle receive signal and decoding the active receive signal comprise code division multiplexing.

### BRIEF DESCRIPTION OF THE DRAWINGS

A more complete understanding of the disclosure and the advantages thereof may be acquired by referring to the following description, taken in conjunction with the accompanying drawings and wherein:

FIG. 1 illustrates touch sensor and touch-sensor controller of device configured for mutual-capacitance measurement.

FIGS. 2A and 2B show flow diagrams of drive iterations when a touch sensor is initially touched.

FIG. 3A shows a touch sensor in an active mode of operation.

FIG. 3B shows the touch sensor of FIG. 3A in an idle mode of operation.

FIG. 4A shows a touch sensor, in an active mode of operation, having forty X lines, which form the drive electrode lines of touch sensor.

FIG. 4B shows a four line codeset, which is not being applied to any drive electrode lines, but is shown for illustration.

FIG. 4C shows the touch sensor of FIG. 4A in an idle mode of operation.

FIG. 5A shows a 4codeset in a horizontal orientation. FIG. 5B shows the same 4codeset as shown in FIG. 5A, but in a vertical orientation.

FIG. 6 shows a flow chart of a touch sensor system switching from an idle mode to an active mode and switching back to the idle mode.

FIG. 7A shows timing diagrams of codesets being applied to forty drive lines in an active mode.

FIG. 7B shows a timing diagram of a normal 20codeset being applied to forty drive lines in an active mode.

FIG. 8A shows a plurality of X lines and a plurality of Y lines of a touch sensor, wherein timing diagrams for drive signals are shown.

FIG. 8B shows the same plurality of X lines and a plurality of Y lines of the touch sensor as shown in FIG. 8A, with a timing diagram of a single codeset being applied to lines 1-12, simultaneously, which may represent an idle mode.

FIG. 9A shows a diagram of a physical touchscreen, wherein codebits are driven line-by-line when driving in an active mode.

FIG. 9B shows a diagram of the physical touchscreen of FIG. 9A, wherein a codebit is driven across multiple lines simultaneously when driving in an idle mode.

FIG. 10A shows resulting scans of a single touch (one finger) and a double touch (two fingers), when the system is the CDM-20 active mode illustrated by FIG. 9A, wherein the drive results decode into the area of the forty x-lines.

FIG. 10B shows resulting scans of a single touch (one finger) and a double touch (two fingers), when the system is in the expanded-CDM-4 idle mode illustrated by FIG. 9B wherein the expanded drive results decode into the area of the first four x-lines.

FIG. 11 shows a flow chart of a method for switching a touch screen system between idle and active modes.

FIG. 12A shows a table of the first touch latency for a test touch screen. FIG. 12B shows a timeline of a voltage when a metal finger touch occurs on the touchscreen wherein the latency is indicated. FIG. 12C provides a bar chart indicating the power consumption. FIG. 12D provides a bar chart indicating the power consumption.

FIG. 13 shows a flow chart of a method to identify a first touch with fast processing reduced power consumption.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided a touchscreen driven with drive signals with codesets to improve first touch latency and reduce idle power consumption.

There is a time latency between a touch occurring, the system processing that touch, and the user seeing the result. Automotive manufacturers demand fast processing times and will demand faster times in the future. The first touch latency is often the least efficient latency because there can be up to three full cycles of the system before the touch is fully recognized and processed. The more time spent processing, the more power is used. Faster processing means reduced power consumption.

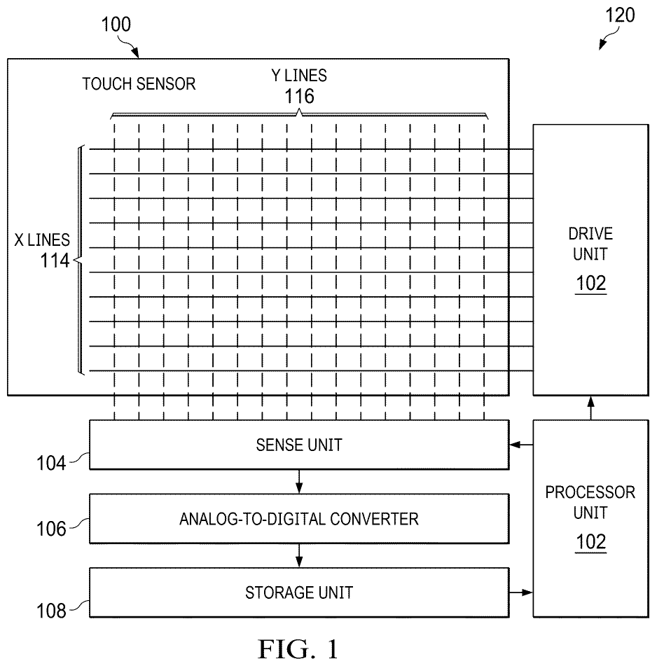

FIG. 1 illustrates touch sensor 100 and touch-sensor controller 120 of device configured for mutual-capacitance measurement. Touch sensor controller 120 may include touch sensor 100, drive unit 102, sense unit 104, analog-to-digital converter (ADC) 106, storage unit 108, and processor unit 112. Herein, reference to touch-sensor controller may comprise one or more of a touch sensor, one or more of a drive unit, one or more of a sense unit, one or more of an ADC, one or more of a storage unit, and one or more of a processor unit where appropriate. Accordingly, touch sensor 100, drive unit 102, sense unit 104, ADC 106, storage unit 108, and processor unit 112 may form internal components of touch-sensor controller 120.

Touch sensor 100 may include an array of drive and sense electrodes (or an array of electrodes of a single type) as described above. Furthermore, touch sensor 100 may include a plurality of X lines 114 and a plurality of Y lines 116. X lines 114 form the drive electrode lines of touch sensor 100 as described above. Herein, reference to X lines 114 may encompass drive electrode lines, and vice versa, where appropriate. Similarly, Y lines 116 form the corresponding sense electrode lines of touch sensor 100 as described above. Herein, reference to Y lines 116 may encompass sense electrode lines, and vice versa, where appropriate.

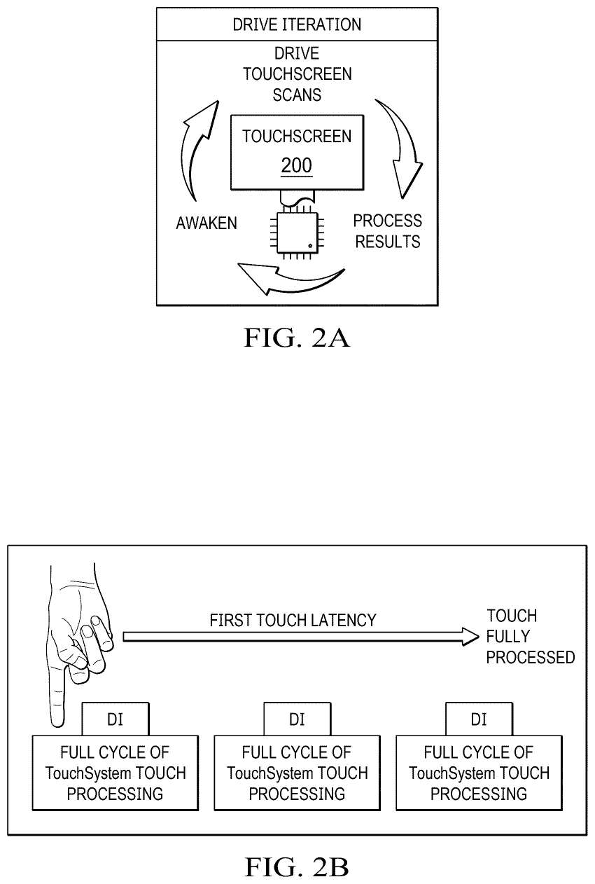

FIGS. 2A and 2B show flow diagrams of drive iterations when a touch sensor 200 is initially touched. A touch occurring late during a drive iteration may not get properly processed. It may be the subsequent drive iteration before the touch is noticed. Once noticed a further subsequent drive iteration will be done. Therefore, as shown in FIG. 2B, it may take up to three drive iterations (DI) to occur for first-touch latency. As touch screen size grows, the number of measurements to scan a screen increases. The additional time to measure larger screen sizes directly affects the first-touch latency. The controller is also active for longer to process the larger number of measurements associated with larger screen sizes, which increases power consumption. To overcome these challenges, one aspect provides for the system to go into an idle mode when no touches are present, so that the touchscreen gets scanned less frequently and the controller processes fewer measurements. When a touch is initially processed during the idle mode, the system switches into an active mode, which scans the touchscreen more frequently and processes relatively more measurements.

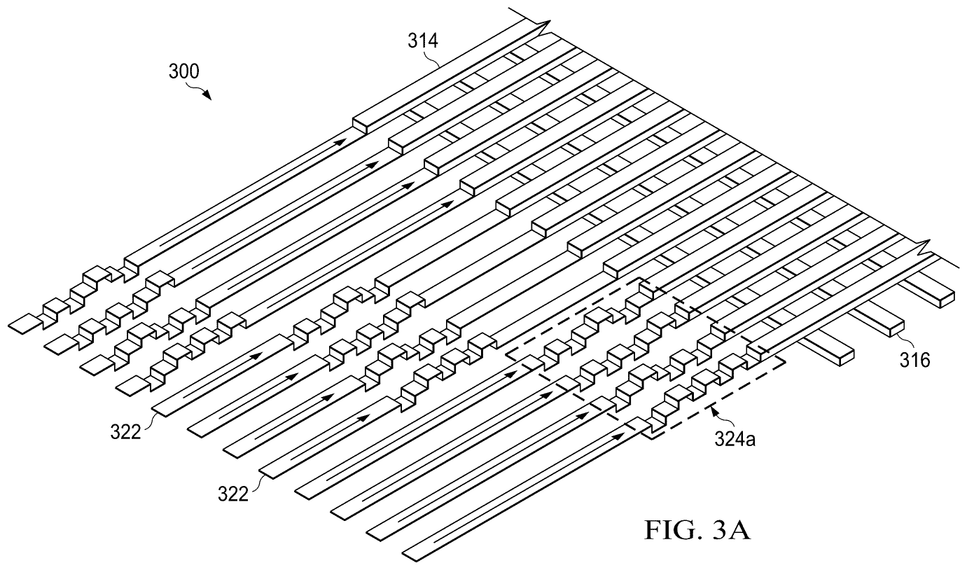

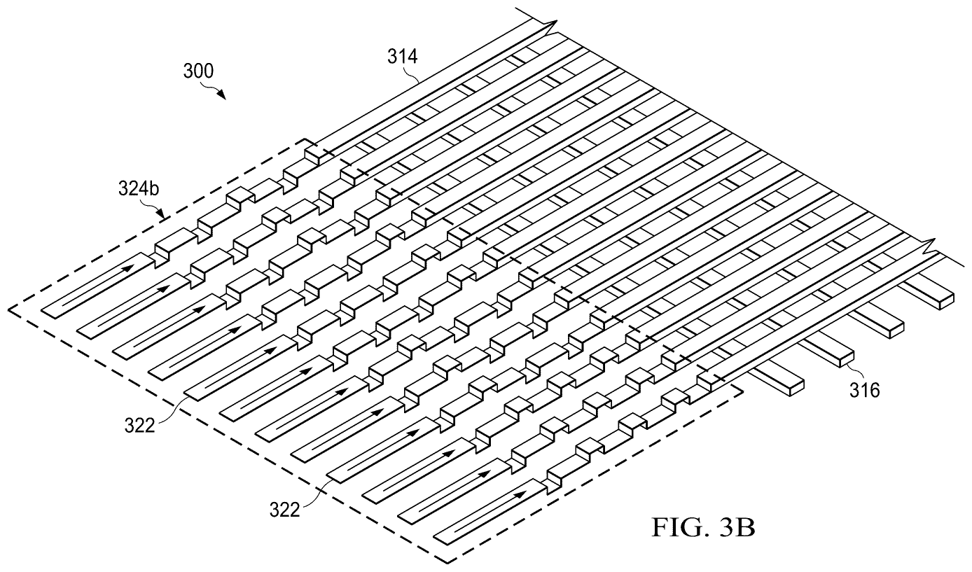

FIG. 3A shows a touch sensor 300 in an active mode of operation. A plurality of X lines 314 and a plurality of Y lines 316. X lines 314 form the drive electrode lines of touch sensor 300 as described above. Drive signal pulses 322 are driven into the X lines 314 at one side of a touch sensor 300 in batches of “codesets” 324a. As shown, three codesets 324a are driving twelve X lines 314, wherein a single codeset 324a drives four X lines 314. In this active mode, respective ones of codesets 324a are driven offset in time, or phase shifted from one another. Codesets 324a may be any number of lines, but in the active mode shown operating twelve X lines, codesets 324a have four lines.

FIG. 3B shows the touch sensor 300 of FIG. 3A in an idle mode of operation. The plurality of X lines 314 and the plurality of Y lines 316 are in the same configuration as shown in FIG. 3A. However, in an idle mode, a single codeset 324b is expanded so that all X lines 314 of the touch sensor 300, or at least a large number of lines (i.e., more than four lines), are driven simultaneously by the single codeset 324b. Driving a single codeset may save time and reduce power consumption. Codeset sizes can vary from four upward, but by expanding a size four codeset, there is less processing to be done later after measurements are received, and more time is therefore saved.

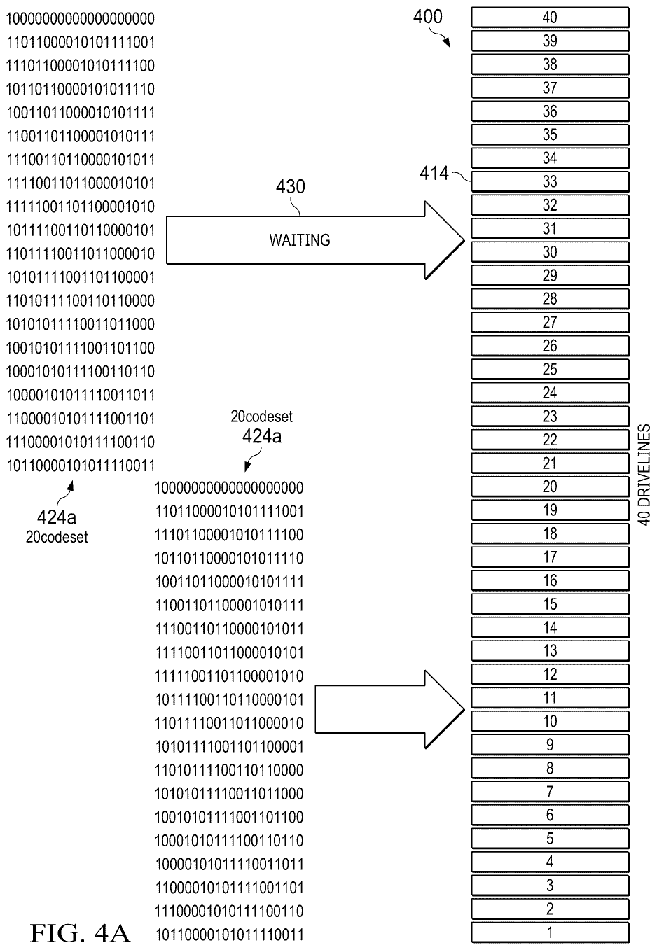

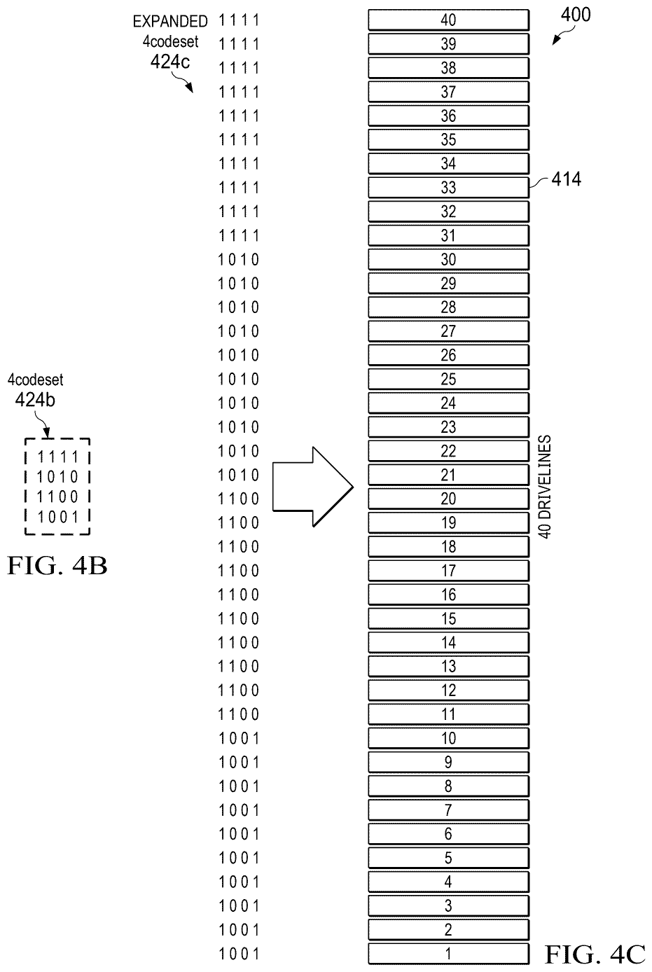

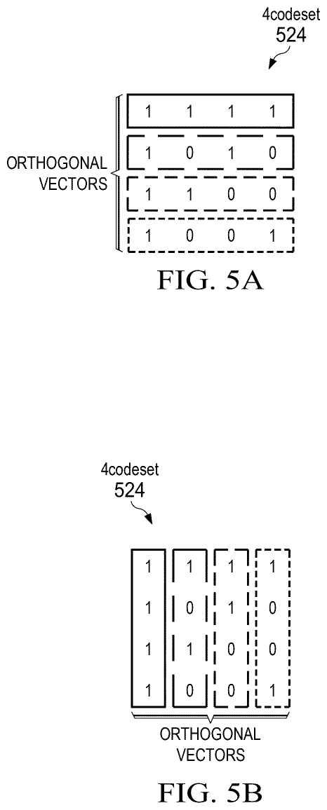

FIG. 4A shows a touch sensor 400, in an active mode of operation, having forty X lines 414, which form the drive electrode lines of touch sensor 400 as described above. Drive signal pulses are driven into the X lines 414 at one side of the touch sensor 400 in batches of “codesets” 424a. As shown, two codesets 424a are driving forty X lines 414 in an active mode. In this active mode, respective ones of codesets 424a are driven offset in time, or phase shifted from one another, wherein there is a waiting interval 430 between the codesets 424a being applied to drive the X lines 414. There is a waiting interval 430 (time offset) here, as drivelines 21 to 40 do not start getting driven until the lower drive lines 1 to 20 have been driven first. Codesets 424a may be any number of lines, but in the active mode shown operating forty X lines, codesets 424a have twenty lines.

FIG. 4B shows a four line codeset 242b, which is not being applied to any drive electrode lines, but is shown for illustration. Individual lines of the codeset have different pulse signal patterns. The first line of the codeset 424b is 1001. The second line of the codeset 424b is 1100. The third line of the codeset 424b is 1010. The fourth line of the codeset 424b is 1111.

FIG. 4C shows the touch sensor 400 of FIG. 4A in an idle mode of operation. The plurality of X lines 414 are in the same configuration as shown in FIG. 4A. However, in an idle mode, a single codeset 424c is expanded so that all X lines 414 of the touch sensor 400, or at least a large number of lines (i.e., more than twenty lines), are driven simultaneously by the single codeset 424c. Codeset sizes can vary from twenty upward, but by expanding a size four codeset, there is less processing to be done later after measurements are received, and more time is therefore saved. In particular, the single codeset 424c having forty lines is expanded from codeset 424b having four lines. The lines 1 to 10 of codeset 424c are the same as the first line of codeset 424b—1001. The lines 11 to 20 of codeset 424c are the same as the second line of codeset 424b—1100. The lines 21 to 30 of codeset 424c are the same as the third line of codeset 424b—1010. The lines 31 to 40 of codeset 424c are the same as the fourth line of codeset 424b—1111. Thus, codeset 424c is an expanded codeset 424b described as 4codeset.

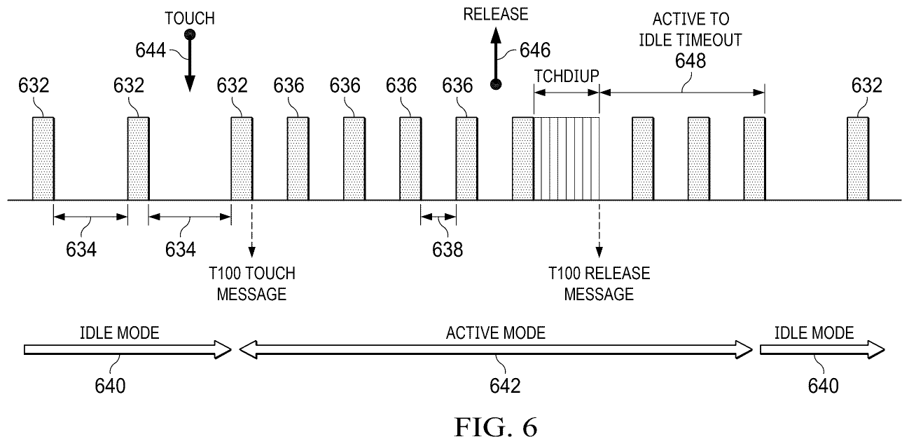

FIG. 5A shows a 4codeset 524 in a horizontal orientation. FIG. 5B shows the same 4codeset 524 as shown in FIG. 5A, but in a vertical orientation. Respective lines of the 4codeset are vectors. FIG. 5A shows 4codeset 524 vectors when considering the 4codeset 524 as rows. FIG. 5B shows 4codeset 524 vectors when considering the 4codeset 524 as columns. An individual line of the 4codeset 524 is a vector that is orthogonal with every other vector in the same 4codeset 524, and this is true in both directions (row-wise or column-wise). Vectors of codeset of other sizes may also be orthogonal. For example, a 20codeset may have vectors that are orthogonal in both directions (row-wise or column-wise).

However, note that the EXPANDED 4codeset 424c shown in FIG. 4C does not contain orthogonal vectors, because it's an expanded version of a 4codeset, and a 4codeset is not driving the X-lines 414, but rather it is an expanded version of a 4codeset. The codeset 424c works when decoding because the decoding algorithm picks out data for just one drive line from an EXPANDED group of ten lines, so the decoding truncates the results back into a 4codeset for process purposes.

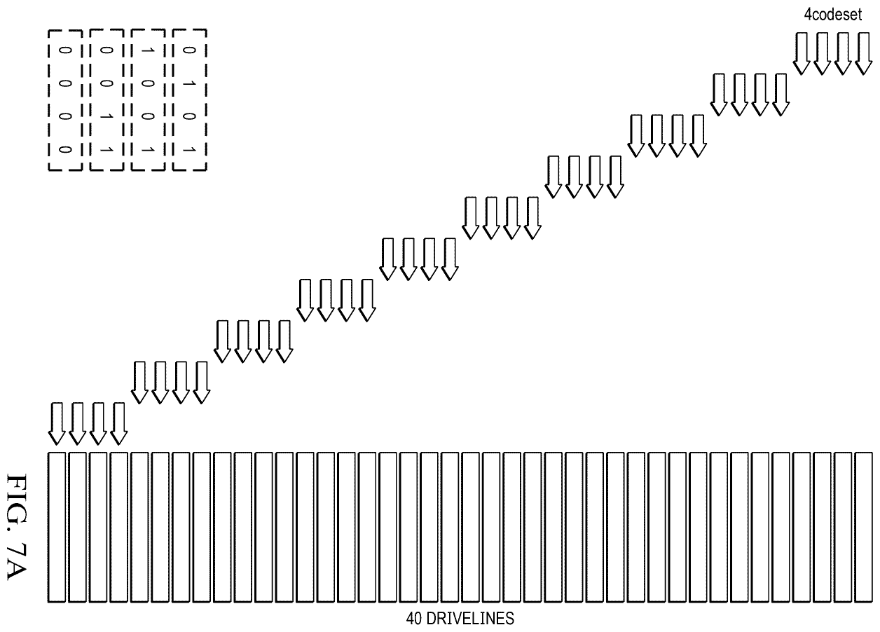

FIG. 6 shows a flow chart of a touch sensor system switching from an idle mode 640 to an active mode 642 and switching back to the idle mode 640. In the idle mode 640, no touches are present on the touch sensor. During idle mode 640, the system idle scans 432 the touch sensor less frequently because it has a relatively longer idle wait interval 634, which is the waiting period between idle scans 632. A touch 644 sends the system into an active mode 642, wherein the system active scans 636 the touch sensor more frequently because the active mode 642 has a relatively shorter active wait intervals 638. After the touch 644, the next idle scan 632 identifies the touch 644 and the processor generates a touch message. The system then switches to the active mode 642 to perform active scans 636 separated by active wait intervals 638. After a touch 644 is ended by a release 646, the processor generates a release message and the system may switch from active mode 642 to idle mode 640 after an active to idle timeout interval 648.

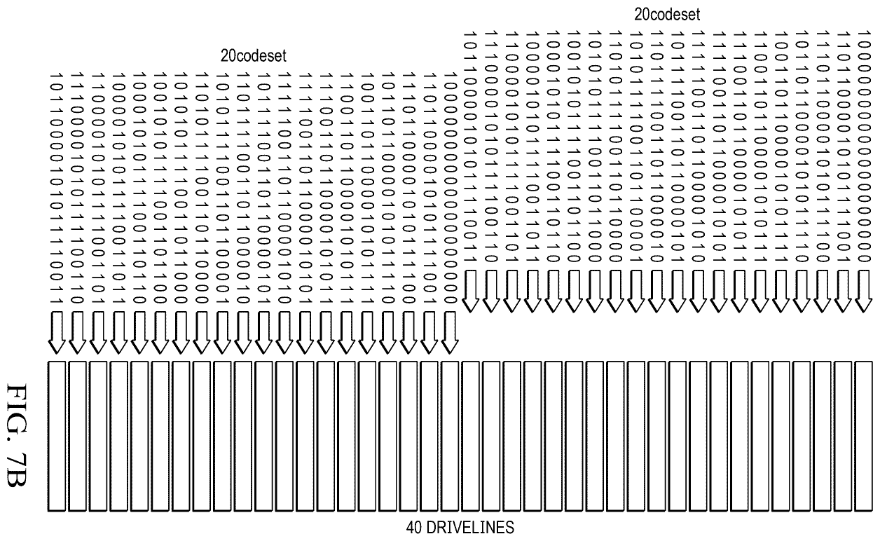

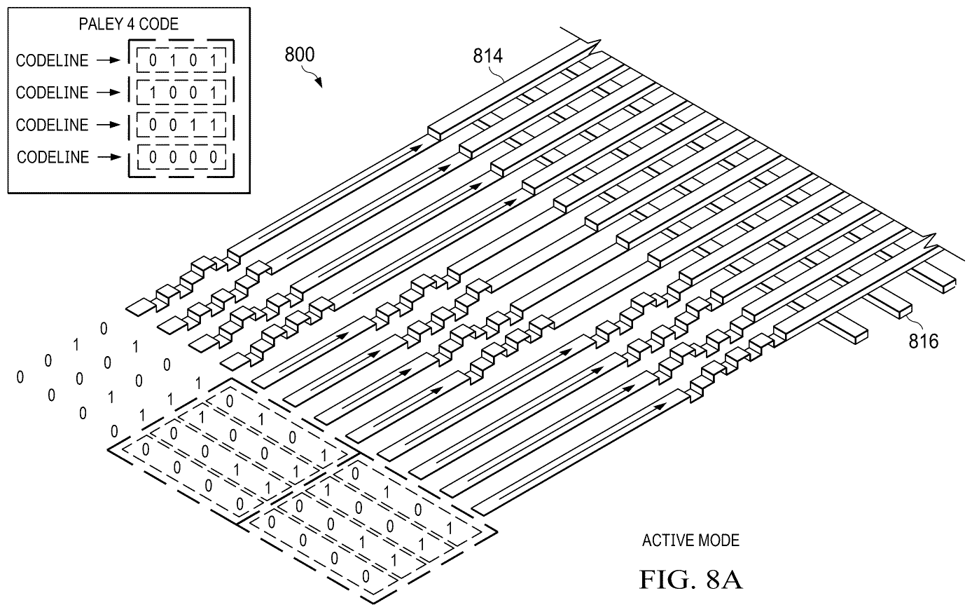

FIG. 7A shows timing diagrams of codesets being applied to forty drive lines in an active mode. Respective ones of codesets are applied to four drive lines. An electrical drive pattern is a precalculated codeset, where respective individual lines are orthogonal to other respective individual lines in the codeset to allow for simultaneous driving of multiple lines. Smaller codesets are quicker to decode while larger codesets take longer to decode.

FIG. 7B shows a timing diagram of a normal 20codeset being applied to forty drive lines in an active mode.

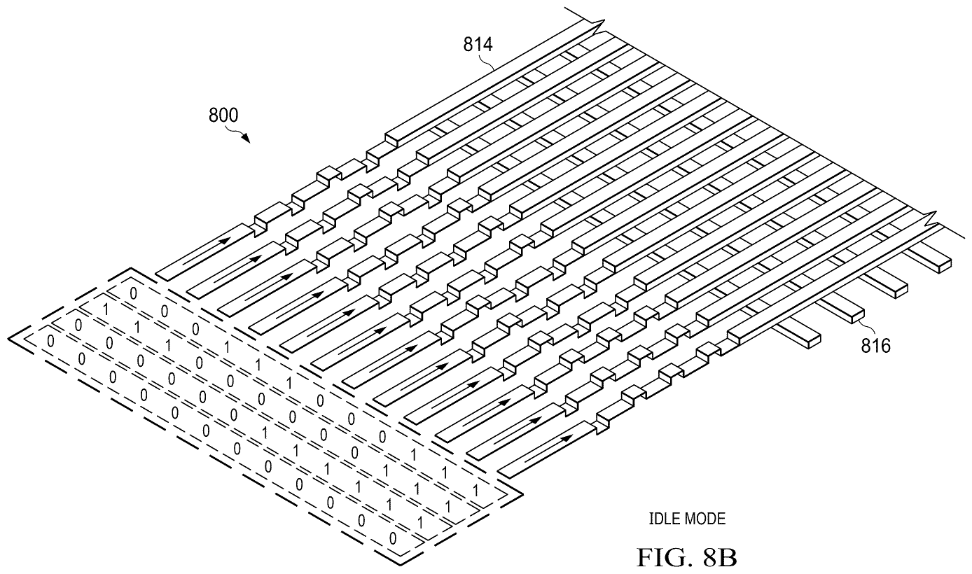

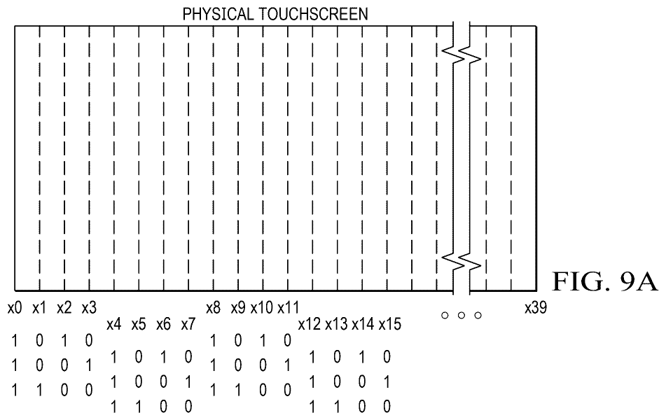

FIG. 8A shows a plurality of X lines 814 and a plurality of Y lines 816 of a touch sensor 800, wherein timing diagrams for drive signals are shown. Codesets, using a Paley 4 Code, are applied to lines 0-3, 4-7, and 8-11, in series, which may represent an active mode. FIG. 8B shows the same plurality of X lines 814 and a plurality of Y lines 816 of a touchscreen as shown in FIG. 8A. However, FIG. 8B shows a timing diagram of a single codeset being applied to lines 1-12, simultaneously, which may represent an idle mode. This relates to the sensing method to detect a touch on a touchscreen. The system changes the sensor drive pattern and associated signal decoding between idle mode and active mode. When in idle mode, the controller drives the same pattern on multiple Tx lines, as shown in FIG. 8B. The touch information from across the touchscreen sensor is effectively compressed into a low number of wider elements. On a detected touch, the controller switches to active mode, as shown in FIG. 8A. Use of idle and active modes, may improve touch sensor first touch latency, and reducing idle power consumption by reducing measurement time.

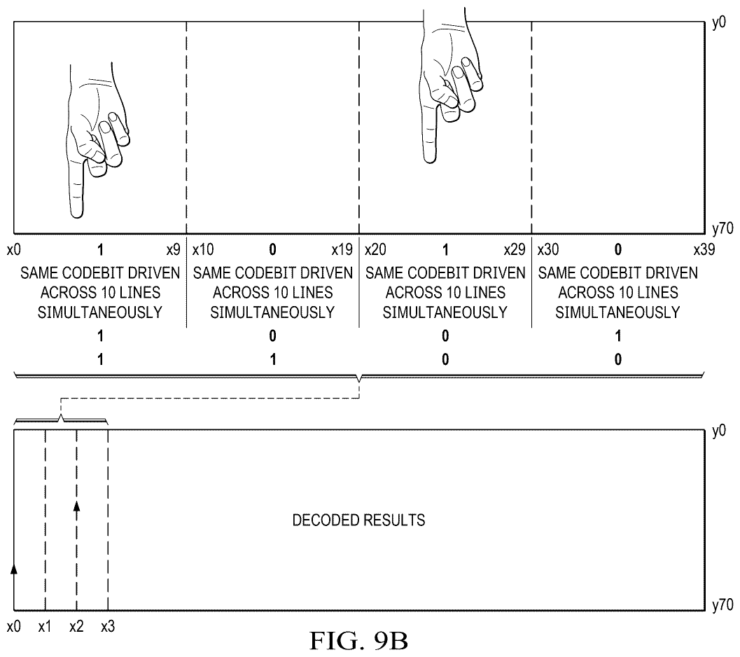

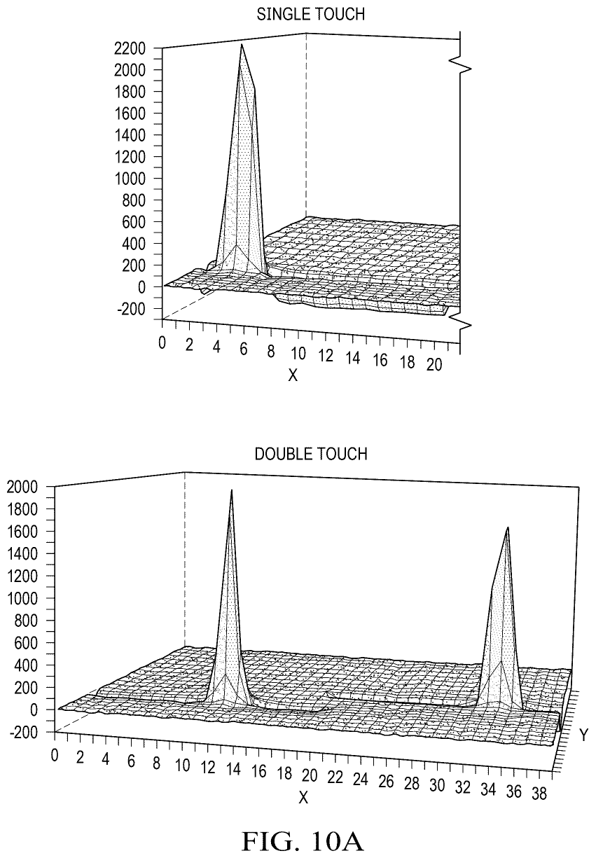

FIG. 9A shows a diagram of a physical touchscreen, wherein codebits are driven line-by-line when driving in an active mode. FIG. 9B shows a diagram of the physical touchscreen of FIG. 9A, wherein a codebit is driven across multiple lines simultaneously when driving in an idle mode. In particular, in the diagram shown in FIG. 9B, a same codebit is driven across 10 lines simultaneously. In the active mode (FIG. 9A), individual X lines are driven with different CDM code bit patterns to allow unambiguous decoding of the sensor data for the individual lines. The touchscreen has forty drive lines (x0-x39) so that forty codebits are being driven.

In the idle mode (FIG. 9B), an expanded CDM codeset is used so that respective ones of the CDM codebit pattern are expanded to drive multiple X lines the same way. The touchscreen still has forty drive lines (x0-x39), but a first codebit is driven simultaneously on the first ten lines (x0-x9), a second codebit is driven simultaneously on the second ten lines (x10-x19), a third codebit is driven simultaneously on the third ten lines (x20-x29), and a fourth codebit is driven simultaneously on the fourth ten lines (x30-x39). Four lines of data are decoded. In the idle mode (FIG. 9B), the system completes a scan of the touchscreen with relatively low spatial resolution of touch position, which is not a significant sacrifice because precise location of a first touch is difficult to discern even when codebits are driven line-by-line. The use of the idle mode may reduce initial touchdown latency by using a drive pattern across multiple lines simultaneously, and to decode the subsequent measurements with an algorithm looking primarily for an initial touch of the touchscreen, and if yes, then switching the system to an active mode.

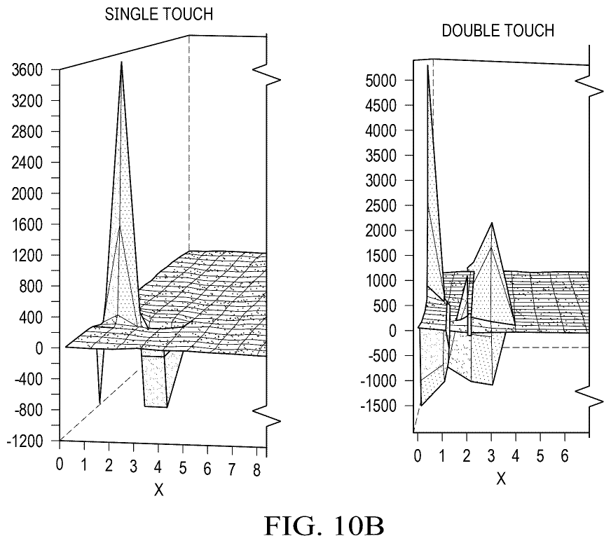

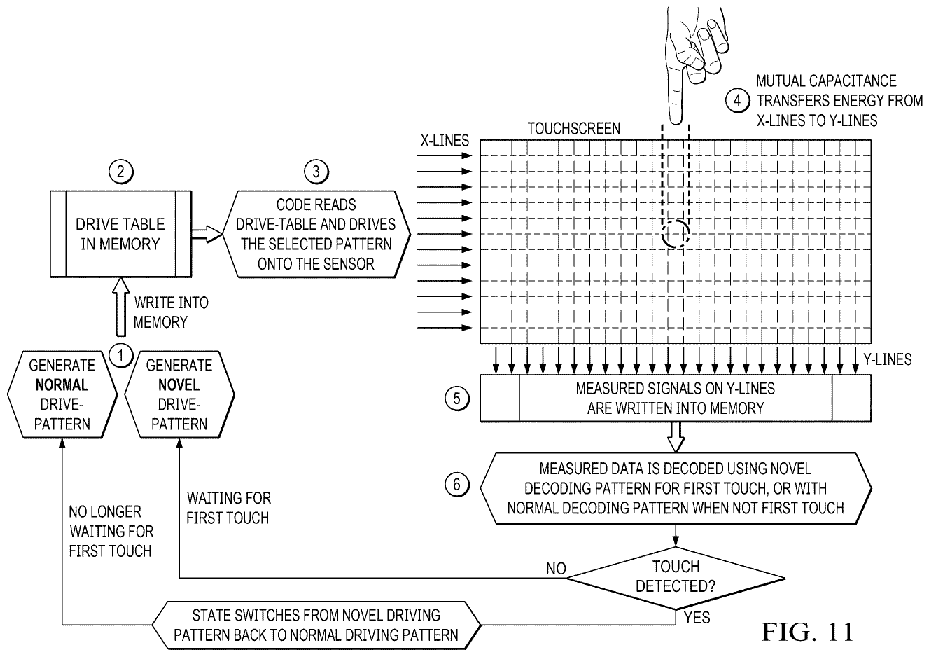

FIG. 10A shows resulting scans of a single touch (one finger) and a double touch (two fingers), when the system is the CDM-20 active mode illustrated by FIG. 9A, wherein the drive results decode into the area of the forty x-lines.

FIG. 10B shows resulting scans of a single touch (one finger) and a double touch (two fingers), when the system is in the CDM-4 idle mode illustrated by FIG. 9B wherein the expanded drive results decode into the area of the first four x-lines.

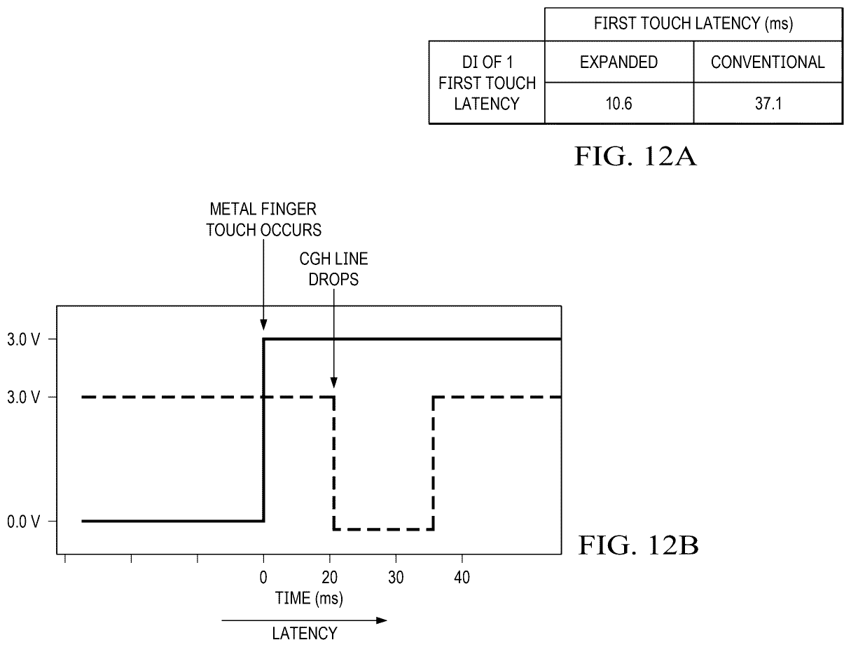

FIG. 11 shows a flow chart of a method for switching a touch screen system between idle and active modes. A low resolution drive pattern is used to scan the touchscreen when the system is in idle mode waiting for a first touch. A high resolution drive pattern is used to scan the touchscreen when the system is in active mode after a first touch has been detected. At block 1, the system begins in an idle mode and generates an idle drive pattern to scan for a first touch of the touch screen. At block 2, the system writes the idle drive pattern into a drive table in memory. At block 3, the system code reads the drive table and drives the idle drive pattern onto the x-lines of the touchscreen. At block 4, the mutual capacitance of the individual nodes transfers energy from the x-lines to the y-lines. At block 5, measured signals on the y-lines are written into memory. At block 6, the measured data is decoded using an idle mode decoding pattern for first touch. If no touch by a finger is detected, the system continues to wait for a first touch, and after an idle scan interval, again generates an idle drive pattern to scan for a first touch of the touch screen. If a touch by a finger is detected, the system switches to an active mode, and after an active scan interval, at block 1, generates an active drive pattern to scan for the touch of the touch screen to locate its position with greater resolution. At block 2, the system writes the active drive pattern into a drive table in memory. At block 3, the system code reads the drive table and drives the active drive pattern onto the x-lines of the touchscreen. At block 4, the mutual capacitance of the individual nodes transfers energy from the x-lines to the y-lines. At block 5, measured signals on the y-lines are written into memory. At block 6, the measured data is decoded using an active mode decoding pattern for a touch.

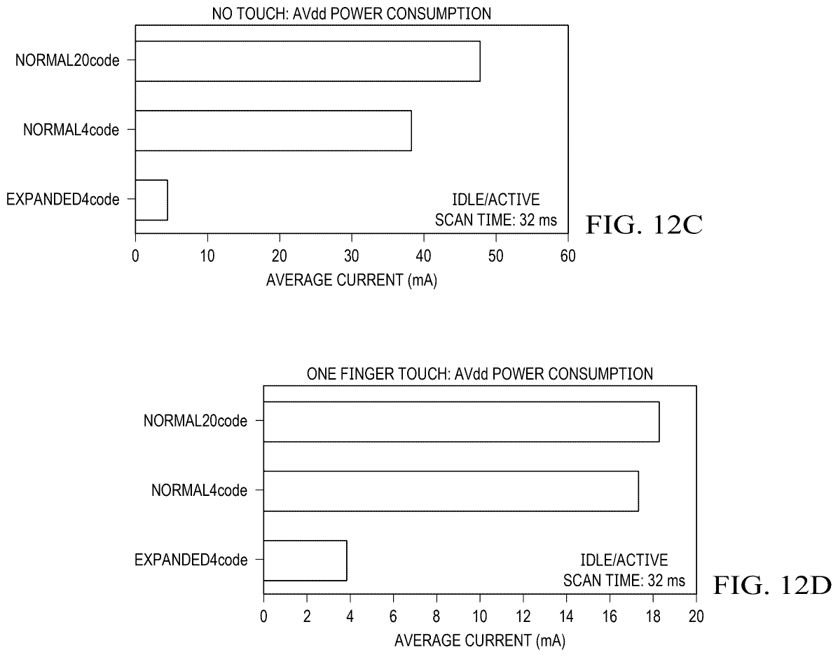

FIG. 12A shows a table of the first touch latency for a test touch screen. In this example, the drive iteration of a first touch latency using idle and active modes is 10.6 ms, and drive iteration of a first touch latency using an active mode by itself is 37.1 ms. FIG. 12B shows a timeline of a voltage when a metal finger touch occurs on the touchscreen wherein the latency is indicated. FIG. 12C provides a bar chart indicating the power consumption over a 32 ms drive iteration with no touch on the touchscreen for: a CDM-20 active mode code; a CDM-4 active mode code; and a CDM-4 idle mode code. FIG. 12D provides a bar chart indicating the power consumption over a 32 ms drive iteration with one touch on the touchscreen for: a CDM-20 active mode code; a CDM-4 active mode code; and a CDM-4 idle mode code.

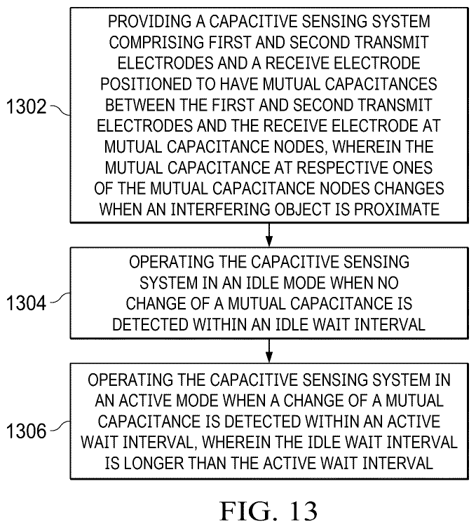

FIG. 13 shows a method for to identify a first touch with fast processing reduced power consumption. A capacitive sensing system is provided 1302 comprising first and second transmit electrodes and a receive electrode positioned to have mutual capacitances between the first and second transmit electrodes and the receive electrode at mutual capacitance nodes, wherein the mutual capacitance at respective ones of the mutual capacitance nodes changes when an interfering object is proximate. The capacitive sensing system is operated 1304 in an idle mode when no change of a mutual capacitance is detected within an idle wait interval. The capacitive sensing system is operated 1306 in an active mode when a change of a mutual capacitance is detected within an active wait interval, wherein the idle wait interval is longer than the active wait interval.

Although examples have been described above, other variations and examples may be made from this disclosure without departing from the spirit and scope of these disclosed examples.

1. A method comprising:
providing a capacitive sensing system comprising first and second transmit electrodes and a receive electrode positioned to have mutual capacitances between the first and second transmit electrodes and the receive electrode at mutual capacitance nodes, wherein the mutual capacitance at respective ones of the mutual capacitance nodes changes when an interfering object is proximate;
operating the capacitive sensing system in an idle mode when no change of a mutual capacitance is detected within an idle wait interval; and
operating the capacitive sensing system in an active mode when a change of a mutual capacitance is detected within an active wait interval,
wherein the idle wait interval is longer than the active wait interval,
wherein the idle mode comprises applying an idle drive pattern to the first and second transmit electrodes,
wherein the active mode comprises applying an active drive pattern to the first and second transmit electrodes, and
wherein the idle drive pattern and the active drive pattern are different drive patterns.

2. The method as in claim 1, wherein the active mode identifies whether a mutual capacitance node has a changed mutual capacitance, and wherein the idle mode identifies which mutual capacitance node has a changed mutual capacitance.

3. (canceled)

4. The method as in claim 1,
wherein applying the idle drive pattern comprises applying simultaneously at least a portion of a single codeset to both the first and second transmit electrodes, and
wherein applying the active drive pattern comprises applying at least portions of different codesets respectively to the first and second transmit electrodes.

5. The method as in claim 1,
wherein operating the capacitive sensing system in the idle mode comprises:
applying simultaneously a first drive signal comprising a codeset to the first and second transmit electrodes;
receiving a receive signal via the receive electrode; and
decoding the receive signal to determine whether there is a change in a mutual capacitance at a mutual capacitance node; and
wherein operating the capacitive sensing system in the active mode comprises:
applying a first drive signal comprising a first codeset to the first transmit electrode and a second drive signal comprising a second codeset to the second transmit electrode;
receiving a receive signal via the receive electrode; and
decoding the receive signal to identify which mutual capacitance node has changed mutual capacitance.

6. The method as in claim 1, further comprising: switching between operating the capacitive sensing system in the idle mode and operating the capacitive sensing system in the active mode.

7. The method as in claim 6, wherein switching is based on whether a change in a mutual capacitance is detected.

8. A system comprising:
first and second transmit electrodes and a receive electrode positioned to have mutual capacitances between the first and second transmit electrodes and the receive electrode at mutual capacitance nodes, wherein the mutual capacitance at respective ones of the mutual capacitance nodes changes when an interfering object is proximate;
a drive signal generator circuit to apply a drive pattern to the first and second transmit electrodes;
a receive signal receiver circuit to receive a receive signal from the receive electrode;
logic circuitry to:
decode the receive signal to detect a change of a mutual capacitance;
operate a capacitive sensing system in an idle mode applying an idle drive pattern to the first and second transmit electrodes when no change of a mutual capacitance is detected within an idle wait interval; and
operate the capacitive sensing system in an active mode applying an active drive pattern to the first and second transmit electrodes when a change of a mutual capacitance is detected within an active wait interval,
wherein the idle wait interval is longer than the active wait interval, and
wherein the idle drive pattern and the active drive pattern are different drive patterns.

9. The system as in claim 8, wherein the idle mode identifies whether a mutual capacitance node has a changed mutual capacitance, and wherein the active mode identifies which mutual capacitance node has a changed mutual capacitance.

10. The system as in claim 8,
wherein the idle drive pattern comprises a single codeset with portions of which to be simultaneously applied to both the first and second transmit electrodes, and
wherein the active drive pattern comprises different codesets with portions of which to be respectively applied to the first and second transmit electrodes.

11. The system as in claim 8,
wherein the logic circuitry is to operate in the idle mode by:
applying simultaneously a first drive signal comprising a codeset with portions being applied to the first and second transmit electrodes;
receiving a receive signal via the receive electrode; and
decoding the receive signal to determine whether there is a change in a mutual capacitance at a mutual capacitance node; and
wherein the logic circuitry is to operate in the active mode by:
applying a first drive signal comprising a first codeset with a portion being applied to the first transmit electrode and a second drive signal comprising a second codeset with a portion being applied to the second transmit electrode;
receiving a receive signal via the receive electrode; and
decoding the receive signal to identify which mutual capacitance node has changed mutual capacitance.

12. The system as in claim 8, wherein the logic circuitry is to switch between operating the capacitive sensing system in the idle mode and operating the capacitive sensing system in the active mode.

13. The system as in claim 12, wherein switching is based on whether a change in a mutual capacitance is detected.

14. A method comprising:
generating an idle drive pattern;
applying an idle drive signal based on the idle drive pattern to a first transmit electrode and a second transmit electrode;
receiving an idle receive signal from a receive electrode, wherein a mutual capacitance at respective ones of mutual capacitance nodes between the first and second transmit electrodes and the receive electrode changes when an interfering object is proximate;
decoding the idle receive signal to determine whether a mutual capacitance has changed;
generating an active drive pattern when it is determined that a mutual capacitance has changed;
applying an active drive signal based on the active drive pattern to the first transmit electrode and the second transmit electrode;
receiving an active receive signal from the receive electrode; and
decoding the active receive signal to determine which mutual capacitance has changed,
wherein the idle drive pattern and the active drive pattern are different drive patterns.

15. The method as in claim 14, comprising waiting an idle wait interval.

16. The method as in claim 15, comprising waiting an active wait interval, wherein the idle wait interval is longer than the active wait interval.

17. The method as in claim 14,
wherein the idle drive pattern comprises an idle codeset,
wherein the active drive pattern comprises an active codeset, and
wherein the idle codeset is applied to more transmit electrodes than the active codeset.

18. The method as in claim 17,
wherein respective codebits of the idle codeset are orthogonal to other respective codebits in the idle codeset to allow for simultaneous driving of multiple transmit electrode, and
wherein respective codebits of the active codeset are orthogonal to other respective codebits in the active codeset to allow for simultaneous driving of multiple transmit electrodes.

19. The method as in claim 14,
wherein the idle drive pattern comprises an idle wait interval,
wherein the active drive pattern comprises an active wait interval, and
wherein the idle wait interval is longer than the active wait interval.

20. The method as in claim 14, wherein decoding the idle receive signal and decoding the active receive signal comprises code division multiplexing.
